(19) United States
(12) Patent Application Publication
(10) Pub. No.: US 2018/0197317 A1
(43) Pub. Date: Jul. 12, 2018

(54) DEEP LEARNING BASED ACCELERATION FOR ITERATIVE TOMOGRAPHIC RECONSTRUCTION

(71) Applicant: General Electric Company, Schenectady, NY (US)

(72) Inventors: Lishui Cheng, Schenectady, NY (US); Bruno Kristiaan Bernard De Man, Clifton Park, NY (US); Sheshadri Thiruvenkadam, Bangalore (IN); Sangtae Ahn, Guilderland, NY (US); Lin Fu, Niskayuna, NY (US); Hao Lai, Niskayuna, NY (US)

(21) Appl. No.: 15/400,763

(22) Filed: Jan. 6, 2017

(51) Int. Cl. G06T 11/00; G06T 7/00; G06N 3/08

(52) U.S. Cl. CPC G06T 11/008; G06T 7/0012; G06N 3/08; G06T 2207/10072; G06T 2207/20076; G06T 2207/20081; G06T 2207/20084

(57) ABSTRACT

The present discussion relates to the use of deep learning techniques to accelerate iterative reconstruction of images, such as CT, PET, and MR images. The present approach utilizes deep learning techniques so as to provide a better initialization to one or more steps of the numerical iterative reconstruction algorithm by learning a trajectory of convergence from estimates at different convergence status so that it can reach the maximum or minimum of a cost function faster.

### BACKGROUND

The subject matter disclosed herein relates to tomographic reconstruction, and in particular to the use of deep learning techniques to accelerate iterative reconstruction approaches.

Non-invasive imaging technologies allow images of the internal structures or features of a patient/object to be obtained without performing an invasive procedure on the patient/object. In particular, such non-invasive imaging technologies rely on various physical principles (such as the differential transmission of X-rays through the target volume, the reflection of acoustic waves within the volume, the paramagnetic properties of different tissues and materials within the volume, the breakdown of targeted radionuclides within the body, and so forth) to acquire data and to construct images or otherwise represent the observed internal features of the patient/object.

All reconstruction algorithms are subject to various trade-offs, such as between computational efficiency, patient dose, scanning speed, image quality, and artifacts. Therefore, there is a need for reconstruction techniques that may provide improved benefits, such as increased reconstruction efficiency or speed, while still achieving good image quality or allowing a low patient dose.

### BRIEF DESCRIPTION

In one embodiment, a neural network training method is provided. In accordance with this method, a plurality of sets of scan data are acquired. An iterative reconstruction of each set of scan data is performed to generate one or more input images and one or more target images for each set of scan data. The one or more input images correspond to lower iteration steps or earlier convergence status of the iterative reconstruction than the one or more target image. A neural network is trained to generate a trained neural network by providing the one or more training images and corresponding one or more target images for each set of scan data to the neural network.

In another embodiment, an iterative reconstruction method is provided. In accordance with this method, a set of scan data is acquired. An initial reconstruction of the set of scan data is performed to generate one or more initial images. The one or more initial images are provided to a trained neural network as inputs. A predicted image or a predicted update is received as an output of the trained neural network. An iterative reconstruction algorithm is initialized using the predicted image or an image using the predicted update. The iterative reconstruction algorithm is run for a plurality of steps to generate an output image.

In a further embodiment, an imaging system is provided. In accordance with this embodiment, the imaging system includes: a data acquisition system configured to acquire a set of scan data from one or more scan components; a processing component configured to execute one or more stored processor-executable routines; and a memory storing the one or more executable-routines. The one or more executable routines, when executed by the processing component, cause acts to be performed comprising: performing an initial reconstruction of the set of scan data to generate one or more initial images; providing the one or more initial images to a trained neural network as inputs; receiving a predicted image or a predicted update as an output of the trained neural network; initializing an iterative reconstruction algorithm using the predicted image or an image generated using the predicted update; and running the iterative reconstruction algorithm for a plurality of steps to generate an output image.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of an artificial neural network for training a deep learning model, in accordance with aspects of the present disclosure;

FIG. 2 is a block diagram depicting components of a computed tomography (CT) imaging system, in accordance with aspects of the present disclosure;

FIG. 3 depicts examples of iterative reconstruction process flows with and without deep learning acceleration, in accordance with aspects of the present disclosure;

FIG. 4 depicts a trajectory of an iterative reconstruction algorithm, in accordance with aspects of the present disclosure;

FIG. 5 graphically depicts steps associated with updating a voxel, in accordance with aspects of the present disclosure;

FIG. 6 depicts a process flow for generating training and/or validation data sets, in accordance with aspects of the present disclosure;

FIG. 7 depicts a process flow for training a deep learning model, in accordance with aspects of the present disclosure;

FIG. 8 depicts a process flow for validating a deep learning model, in accordance with aspects of the present disclosure;

FIG. 9 depicts an example flow of training a deep learning model using image patches, in accordance with aspects of the present disclosure;

FIG. 10 depicts emission and attenuation models used to generate study data, in accordance with aspects of the present disclosure;

FIG. 11 depicts results of a study performed in accordance with aspects of the present disclosure; and

FIG. 12 depicts cost function versus iteration results of a study performed in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure

While aspects of the following discussion are provided in the context of medical imaging, it should be appreciated that the present techniques are not limited to such medical contexts. Indeed, the provision of examples and explanations in such a medical context is only to facilitate explanation by providing instances of real-world implementations and applications. However, the present approaches may also be utilized in other contexts, such as tomographic image reconstruction for industrial Computed Tomography (CT) used in non-destructive inspection of manufactured parts or goods (i.e., quality control or quality review applications), and/or the non-invasive inspection of packages, boxes, luggage, and so forth (i.e., security or screening applications). Moreover, the present techniques are applicable to a wide array of image-domain based optimization problems using iterative algorithms. For example, to accelerate the iterative algorithms used in image processing and analysis such as image denoising/smoothing, non-rigid image registration, image enhancement, and so forth. In general, the present approaches may be desirable in any imaging or screening context or image processing field where the final image is the result of optimizing a cost function for which iterative algorithms are employed.

Furthermore, while the following discussion focuses on standard images or image volumes, it should be understood that the same approach can also be applied to sets of images or image volumes corresponding to different aspects of the scan. For example, spectral CT produces a set of images, including monochromatic images at different energies as well as basis material decomposition images. Or as another example, dynamic CT or PET produces a set of images at different time points. At every iteration of the iterative reconstruction, two or more images are estimated and updated. Hence, the current invention equally applies to these sets of images, where the input to the neural network are multiple sets of images and the prediction is also a set of images. For instance, the input may be monochromatic CT images at 60 keV and 100 keV for iteration numbers 4, 5 and 6, while the output may be monochromatic CT images at 60 keV and 100 keV for iteration number 200.

Further, though CT and positron emission tomography (PET) examples are primarily provided herein, it should be understood that the present approach may be used in other imaging modality contexts that may employ iterative image reconstruction techniques. For instance, the presently described approach may also be suitable for use with other types of X-ray tomographic scanners and/or may also applied to image reconstruction in non-X-ray imaging contexts including, but not limited to, reconstruction using single-photon emission computed tomography (SPECT) images using Bayesian regularized reconstruction of data (e.g., penalized image reconstruction) and/or magnetic resonance (MR) image reconstruction.

In the most general sense an image, as discussed herein, can comprise any array of parameters to be estimated, and iterative reconstruction can comprise any iterative estimation process of these parameters. Hence, another possible application of the proposed approach is to accelerate the training of a neural network, where the network parameters make up the image and are iteratively updated. The network parameters may comprise weights at each node as well as activation energy thresholds. The network is trained iteratively and hence a deep learning method can be applied to estimate the parameters of this other neural network.

With respect to iterative reconstruction, these reconstruction techniques (in contrast to analytical methods) may be desirable for a variety of reasons. Iterative reconstruction algorithms can offer advantages in terms of modeling (and compensating for) the physics of the scan acquisition, modeling the statistics of the measurements to improve the image quality and incorporating prior information. For example, such iterative reconstruction methods may be based on discrete imaging models and may realistically model the system optics, scan geometry, physical effects, and noise statistics. Prior information may be incorporated into the iterative reconstruction using Markov random field neighborhood regularization, Gaussian mixture priors, dictionary learning techniques, and so forth.

As a result, iterative reconstruction techniques often achieve superior image quality, though at relatively high computational cost. For example, model-based iterative reconstruction (MBIR) for CT imaging is a reconstruction technique which iteratively estimates the spatial distribution and values of attenuation coefficients of an image volume from measurements. MBIR is based on an optimization problem whereby a reconstructed image volume is calculated by maximizing or minimizing an objective function containing both data fitting and regularizer terms which in combination control the trade-off between data fidelity and image quality. The data fitting (i.e., data fidelity) term minimizes the error between estimated data obtained from reconstructed images and the acquired data according to an accurate model that takes the noise into consideration. The regularizer term takes the prior knowledge of the image (e.g., attenuation coefficients that are similar within a small neighborhood) to reduce possible artifacts, such as streaks and noise. Therefore, MBIR is tolerant to noise and performs well even in low dose situation. Penalized image reconstruction for other modalities, such as PET, SPECT and MR follows similar principle. The trade-off, however, is that such iterative reconstruction approaches are computationally intensive and may be relatively time consuming, particularly in comparison to analytical reconstruction approaches.

With the preceding introductory comments in mind, the approaches described herein utilize deep learning techniques to accelerate iterative reconstruction of images, such as CT, PET, SPECT, and MR images. As discussed herein, deep learning techniques (which may also be known as deep machine learning, hierarchical learning, or deep structured learning) are a branch of machine learning techniques that employ mathematical representations of data and artificial neural network for learning. By way of example, deep learning approaches may be characterized by their use of one or more algorithms to extract or model high level abstractions of a type of data of interest. This may be accomplished using one or more processing layers, with each layer typically corresponding to a different level of abstraction and, therefore potentially employing or utilizing different aspects of the initial data or outputs of a preceding layer (i.e., a hierarchy or cascade of layers) as the target of the processes or algorithms of a given layer. In an image processing or reconstruction context, this may be characterized as different layers corresponding to the different feature levels or resolution in the data. Processing may therefore proceed hierarchically, i.e., earlier or higher level layers may correspond to higher level or larger features, followed by layers that derive lower level or finer features from the higher level features. In practice, each layer may employ one or more linear and/or non-linear transforms to process the input data to an output data representation for the layer.

As discussed herein, as part of the initial training of deep learning processes to solve a particular problem, training data sets may be employed that have known initial values (e.g., input images) and known or desired values for one or both of the final output (e.g., target images or image updates) of the deep learning process or for individual layers of the deep learning process (assuming a multi-layer algorithmic implementation). In this manner, the deep learning algorithms may process (either in a supervised or guided manner or in an unsupervised or unguided manner) the known or training data sets until the mathematical relationships between the initial data and desired output(s) are discerned and/or the mathematical relationships between the inputs and outputs of each layer are discerned and characterized. Similarly, separate validation data sets may be employed in which both input and desired target values are known, but only the initial values are supplied to the trained deep learning algorithms, with the outputs then being compared to the outputs of the deep learning algorithm to validate the prior training and/or to prevent over-training.

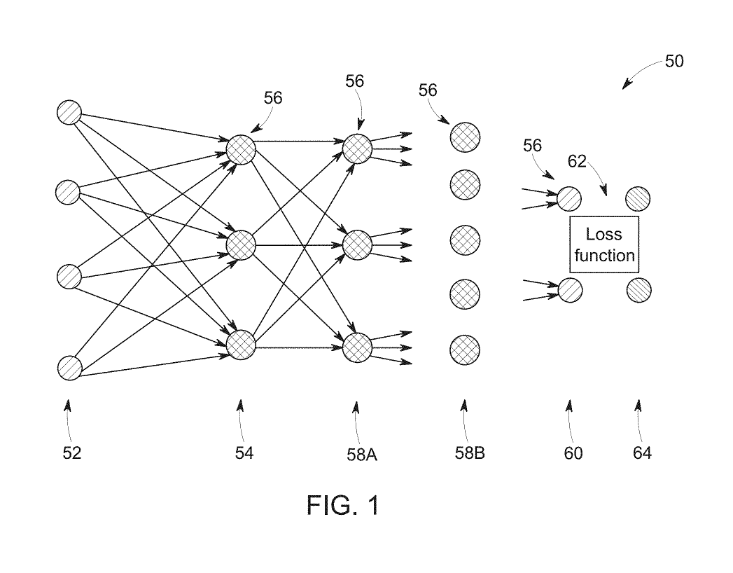

By way of visualization, FIG. 1 schematically depicts an example of an artificial neural network 50 that may be trained as a deep learning model as discussed herein. In this example, the network 50 is multi-layered, with a training input 52 and multiple layers including an input layer 54, hidden layers 58A, 58B, and so forth, and an output layer 60 and the training target 64 present in the network 50. Each layer, in this example, is composed of a plurality of “neurons” 56. The number of neurons 56 may be constant between layers or, as depicted, may vary from layer to layer. Neurons 56 at each layer generate respective outputs that serve as inputs to the neurons 56 of the next hierarchical layer. In practice, a weighted sum of the inputs with an added bias is computed to “excite” or “activate” each respective neuron of the layers according to an activation function, such as rectified linear unit (ReLU) or otherwise specified or programmed. The outputs of the final layer constitute the network output 60 (e.g., predicted image, I_{pred}) which, in conjunction with a target image 64, are used to compute some loss or error function 62, which will be backpropagated to guide the network training

The loss or error function 62 measures the difference between the network output (i.e., I_{pred}) and the training target (i.e., I_{N}) (see FIG. 4). In certain implementations, the loss function may be the mean squared error (MSE) of the voxel-level values and/or may account for differences involving other image features, such as image gradients or other image statistics. Alternatively, the loss function 62 could be defined by other metrics associated with the particular task in question.

To facilitate explanation of the present iterative reconstruction acceleration using deep learning techniques, the present disclosure primarily discusses these approaches in the context of a CT or PET system. However, it should be understood that the following discussion may also be applicable to other image modalities and systems including, but not limited to, SPECT, magnetic resonance imaging (MRI), as well as to non-medical contexts or any context where iterated reconstruction steps are employed to reconstruct an image. Moreover, the same principle and similar approaches are applicable to image processing problem where an iterative algorithm is used to optimize a cost function to generate the final desired image.

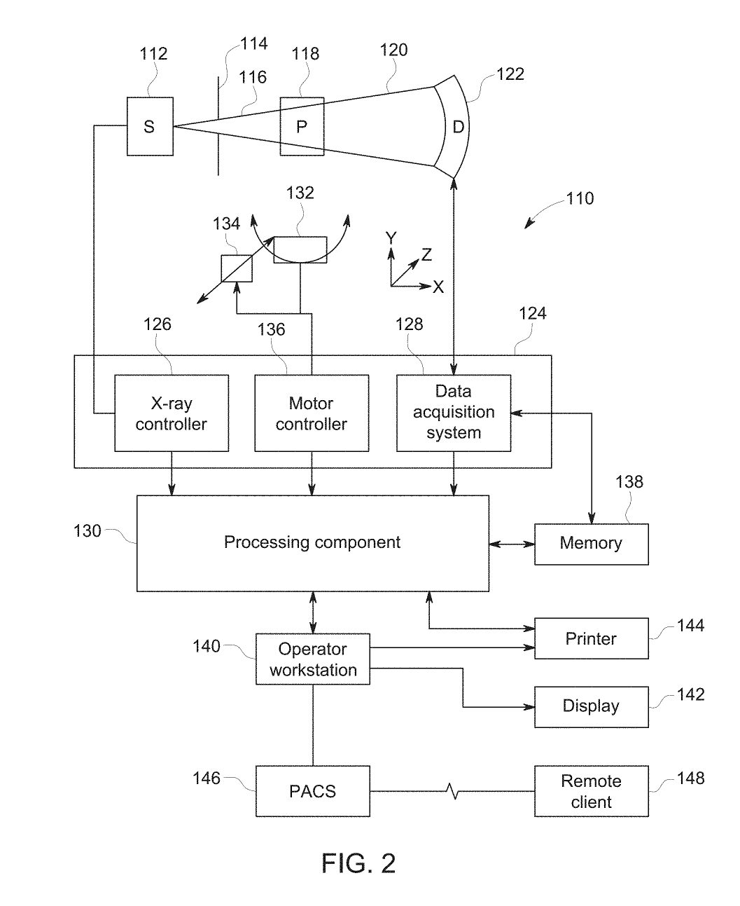

With this in mind, an example of an imaging system 110 (i.e., a scanner) is depicted in FIG. 2. In the depicted example, the imaging system 110 is a CT imaging system designed to acquire scan data (e.g., X-ray attenuation data) at a variety of views around a patient (or other subject or object of interest) and suitable for performing image reconstruction using iterative reconstruction techniques. In the embodiment illustrated in FIG. 2, imaging system 110 includes a source of X-ray radiation 112 positioned adjacent to a collimator 114. The X-ray source 112 may be an X-ray tube, a distributed X-ray source (such as a solid-state or thermionic X-ray source) or any other source of X-ray radiation suitable for the acquisition of medical or other images. Conversely, in a PET embodiment, a toroidal radiation detector may be provided and the X-ray source may be absent.

In the depicted example, the collimator 114 shapes or limits a beam of X-rays 116 that passes into a region in which a patient/object 118, is positioned. In the depicted example, the X-rays 116 are collimated to be a cone-shaped beam, i.e., a cone-beam, that passes through the imaged volume. A portion of the X-ray radiation 120 passes through or around the patient/object 118 (or other subject of interest) and impacts a detector array, represented generally at reference numeral 122. Detector elements of the array produce electrical signals that represent the intensity of the incident X-rays 120. These signals are acquired and processed to reconstruct images of the features within the patient/object 118.

Source 112 is controlled by a system controller 124, which furnishes both power, and control signals for CT examination sequences, including acquisition of two-dimensional localizer or scout images used to identify anatomy of interest within the patient/object for subsequent scan protocols. In the depicted embodiment, the system controller 124 controls the source 112 via an X-ray controller 126 which may be a component of the system controller 124. In such an embodiment, the X-ray controller 126 may be configured to provide power and timing signals to the X-ray source 112.

Moreover, the detector 122 is coupled to the system controller 124, which controls acquisition of the signals generated in the detector 122. In the depicted embodiment, the system controller 124 acquires the signals generated by the detector using a data acquisition system 128. The data acquisition system 128 receives data collected by readout electronics of the detector 122. The data acquisition system 128 may receive sampled analog signals from the detector 122 and convert the data to digital signals for subsequent processing by a processor 130 discussed below. Alternatively, in other embodiments the digital-to-analog conversion may be performed by circuitry provided on the detector 122 itself. The system controller 124 may also execute various signal processing and filtration functions with regard to the acquired image signals, such as for initial adjustment of dynamic ranges, interleaving of digital image data, and so forth.

In the embodiment illustrated in FIG. 2, system controller 124 is coupled to a rotational subsystem 132 and a linear positioning subsystem 134. The rotational subsystem 132 enables the X-ray source 112, collimator 114 and the detector 122 to be rotated one or multiple turns around the patient/object 118, such as rotated primarily in an x,y-plane about the patient. It should be noted that the rotational subsystem 132 might include a gantry upon which the respective X-ray emission and detection components are disposed. Thus, in such an embodiment, the system controller 124 may be utilized to operate the gantry.

The linear positioning subsystem 134 may enable the patient/object 118, or more specifically a table supporting the patient, to be displaced within the bore of the CT system 110, such as in the z-direction relative to rotation of the gantry. Thus, the table may be linearly moved (in a continuous or step-wise fashion) within the gantry to generate images of particular areas of the patient 118. In the depicted embodiment, the system controller 124 controls the movement of the rotational subsystem 132 and/or the linear positioning subsystem 134 via a motor controller 136.

In general, system controller 124 commands operation of the imaging system 110 (such as via the operation of the source 112, detector 122, and positioning systems described above) to execute examination protocols and to process acquired data. For example, the system controller 124, via the systems and controllers noted above, may rotate a gantry supporting the source 112 and detector 122 about a subject of interest so that X-ray attenuation data may be obtained at one or more views relative to the subject. In the present context, system controller 124 may also include signal processing circuitry, associated memory circuitry for storing programs and routines executed by the computer (such as routines for executing accelerated image processing or reconstruction techniques described herein), as well as configuration parameters, image data, and so forth.

In the depicted embodiment, the image signals acquired and processed by the system controller 124 are provided to a processing component 130 for reconstruction of images in accordance with the presently disclosed algorithms. The processing component 130 may be one or more general or application-specific microprocessors. The data collected by the data acquisition system 128 may be transmitted to the processing component 130 directly or after storage in a memory 138. Any type of memory suitable for storing data might be utilized by such an exemplary system 110. For example, the memory 138 may include one or more optical, magnetic, and/or solid state memory storage structures. Moreover, the memory 138 may be located at the acquisition system site and/or may include remote storage devices for storing data, processing parameters, and/or routines for image reconstruction, as described below.

The processing component 130 may be configured to receive commands and scanning parameters from an operator via an operator workstation 140, typically equipped with a keyboard and/or other input devices. An operator may control the system 110 via the operator workstation 140. Thus, the operator may observe the reconstructed images and/or otherwise operate the system 110 using the operator workstation 140. For example, a display 142 coupled to the operator workstation 140 may be utilized to observe the reconstructed images and to control imaging. Additionally, the images may also be printed by a printer 144 which may be coupled to the operator workstation 140.

Further, the processing component 130 and operator workstation 140 may be coupled to other output devices, which may include standard or special purpose computer monitors and associated processing circuitry. One or more operator workstations 140 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 140 may also be coupled to a picture archiving and communications system (PACS) 146. PACS 146 may in turn be coupled to a remote client 148, radiology department information system (RIS), hospital information system (HIS) or to an internal or external network, so that others at different locations may gain access to the raw or processed image data.

While the preceding discussion has treated the various exemplary components of the imaging system 110 separately, these various components may be provided within a common platform or in interconnected platforms. For example, the processing component 130, memory 138, and operator workstation 140 may be provided collectively as a general or special purpose computer or workstation configured to operate in accordance with the aspects of the present disclosure. In such embodiments, the general or special purpose computer may be provided as a separate component with respect to the data acquisition components of the system 110 or may be provided in a common platform with such components. Likewise, the system controller 124 may be provided as part of such a computer or workstation or as part of a separate system dedicated to image acquisition.

The system of FIG. 2 may be utilized to acquire X-ray projection data (or other scan data for other modalities) for a variety of views about a region of interest of a patient to reconstruct images of the imaged region using the scan data. Projection (or other) data acquired by a system such as the imaging system 110 may be iteratively reconstructed using deep learning approaches as discussed herein to accelerate the reconstruction processing. In particular, the present approach utilizes deep learning techniques so as to provide a better initialization to one or more steps of the numerical iterative reconstruction algorithm by learning a trajectory of convergence from estimates at different convergence status so that it can reach the maximum or minimum of a cost function faster. In essence the present approach may be construed as taking one or more images at one or more early stages of the iterative reconstruction (e.g., 1, 2, 3, steps and so forth) and using trained deep learning algorithms to obtain an estimate of what the image will look like in some number of iterative reconstruction steps in the future (e.g., 10, 50, 100, 200, 500, steps, and so forth).

The estimated image may then be used in the iterative reconstruction so as to effectively move ahead that many steps in the reconstruction process, without performing the intervening iterative reconstruction steps. While the present approach may be used to effectively skip from the beginning of the iterative reconstruction to the final image, in practice it may instead be useful to apply the approach one or more times during reconstruction so as to jump ahead in a more discrete and controlled manner so as to allow the reconstruction algorithms to make adjustments as needed throughout the process. For example, the present approach may be applied after a certain number of iterative reconstruction steps to jump ahead 50, 100, 500, or a 1000 steps, and then allow the conventional reconstruction steps to proceed as usual, thereby saving the computational time associated with the number of steps skipped. Alternatively, the present approach may instead be applied multiple times (e.g., 2, 3, 4, 5, 10) over the course of the reconstruction to jump ahead some number of steps (e.g., 25, 50, 100, 500) each application, and then allow the reconstruction to proceed after each application for some number of steps so that the reconstruction process may make any needed corrections or adjustments as needed. In such uses, different instances or applications of the deep learning acceleration during a single reconstruction may jump ahead different numbers of steps. Further, in such uses, the deep learning algorithm employed at different stages of the iterative reconstruction process may be differently trained (i.e., a different algorithm) to account for the respective stage of the reconstruction process. In such an example, for new data (i.e., in clinical or diagnostic use, the patient data), it may be reconstructed up to the point or in a manner corresponding to what the deep learning acceleration algorithms were trained to receive as inputs. Alternatively, in other instances the same algorithm may be employed regardless of the stage of the reconstruction process.

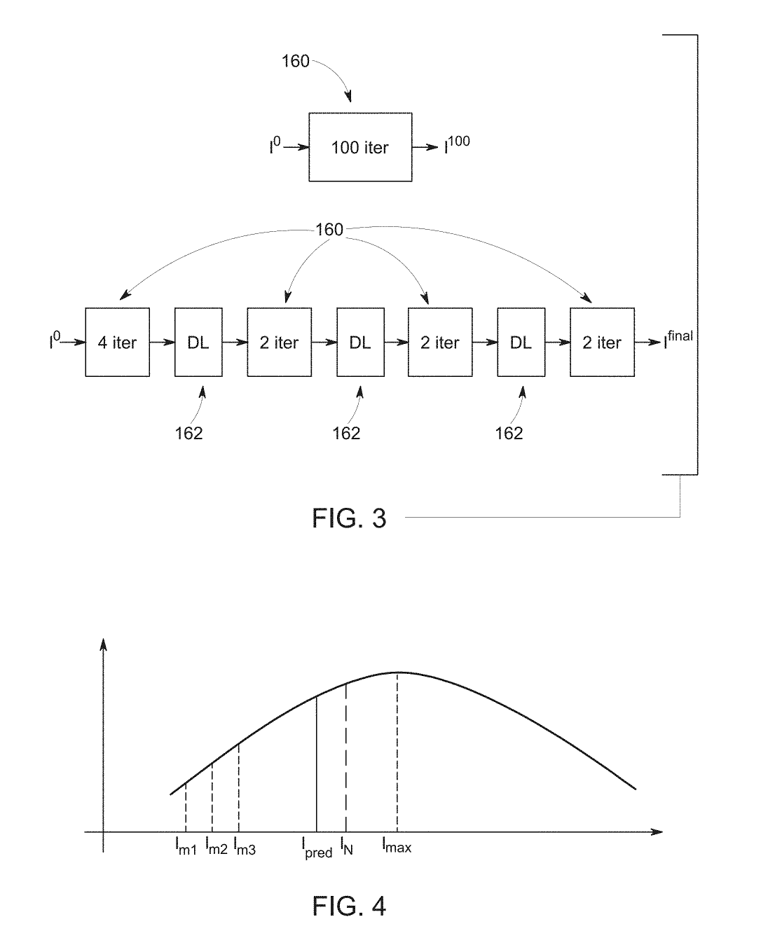

An example of this concept is shown in FIG. 3, where in the topmost example, no deep learning acceleration is employed such that 100 iterative reconstruction steps (step 160) applied to the initial image I° yields a non-final image, here I¹⁰⁰ that is 100 steps into the unaccelerated iterative reconstruction process. Conversely, as shown in the bottom example, iterative reconstruction steps 160 are interspersed with separate, discrete deep learning acceleration instances 162 such that a limited number of iterative reconstruction steps achieve a final image, here I^{final}. In this example, four iterative reconstruction steps are applied to the initial image data and the resulting estimate fed to a deep learning acceleration step, the output of which undergoes two iterative reconstruction steps, and so forth, with only a total of 10 iterative reconstruction steps being performed in this example to reconstruct a final image.

A simple example of the above discussion is shown in FIG. 4, where a single application of the present approach is depicted. In this example, a trajectory of an iterative reconstruction algorithm for optimization is depicted. The horizontal axis represents an image and the vertical axis represents a cost function value. Some initial estimated images at an early stage of the iterative reconstruction (here Iₘ₁, Iₘ₂, and Iₘ₃) are shown. I_{N} is the image estimate at some larger iteration number. In the depicted example one or more of the initial estimated images Iₘ₁, Iₘ₂, and Iₘ₃ are input to a trained deep learning algorithm. The deep learning algorithm is trained to take inputs such as those provided (i.e., at this or a similar stage of the reconstruction) and generate a predicted image (I_{pred}) some defined number of steps ahead in the iterative reconstruction process. I_{pred} may then be used as a new initialization of the iterative reconstruction algorithm, allowing I_{N}, and ultimately Iₘₐₓ, to be reached in fewer reconstruction steps, where Iₘₐₓ corresponds to the optimal result where the cost function defined by the depicted curve is satisfied (here, maximized). In this manner, the iterative reconstruction is able to effectively skip the reconstruction steps between Iₘ₃ and I_{pred}, resulting in improved reconstruction speed and computational efficiency.

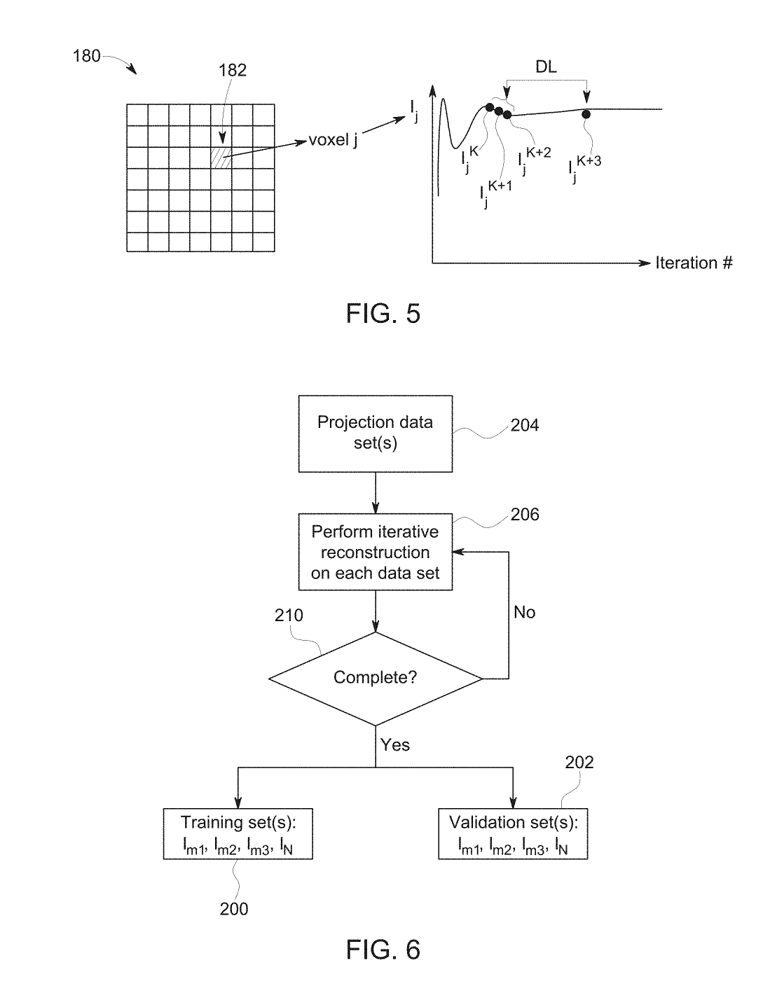

To further illustrate the present concepts, FIG. 5 depicts a similar example, but in the context of the updating of a given voxel 182 (i.e., voxel j) of an image 180 undergoing reconstruction. In this example, the value (e.g., intensity, shown along the vertical axis of the right-hand graph) of voxel j changes as a function of iteration number K (shown along the horizontal axis of the right-hand graph). In this example, the intensity at three consecutive iterations (K, K+1, K+2) is shown. These values are input to a deep learning algorithm trained to receive as inputs values from this stage of the reconstruction and to output a voxel output (e.g., intensity value) corresponding to what would be observed after some number of iterations more in the future (e.g., 25, 50, 100, 200 iterations). This value may then be used as an input or new initialization to the iterative reconstruction algorithm such that the next iteration (K+3) is effectively further along the typical iteration function or expectation.

While the preceding has generally described the use of deep learning approaches for estimating a predicted image that may be used to reinitialize a reconstruction process at a later stage. Conversely, one could instead predict the update to the previous estimate to define a current estimate. That is, I_{N}=Iₘ₃+ΔI_{pred}, where the deep learning model learns to predict ΔI_{pred} from {Iₘ₁, Iₘ₂, Iₘ₃}, with reference to FIG. 4. The advantage of such an approach is that weight regularization such as dropout or sparsity would only affect the update and not the original estimate I_{N}, enabling robust recovery.

With the preceding in mind, and turning to FIGS. 6-9, various process flows and examples related to training and validation of deep learning models as discussed herein are presented. Turning to FIG. 6, multiple training data sets 200 and/or validation data sets 202 are generated from a plurality of suitable scan data sets. In a CT context, these may be projection data sets 204. In other contexts, these may be different types of data, such as time of flight data in a PET image reconstruction context. For each set of data 204 (and with reference to FIG. 4), the appropriate iterative reconstruction algorithm is run (step 206) to a target iteration number N (e.g., a large iteration number, such as 50, 75, 100, 150, 200, or 500 iteration). Early iteration image estimates (e.g., Iₘ₁, Iₘ₂, and Iₘ₃, at low iterations numbers m1, m2, m3) that are less than N and the image estimate I_{N} at iteration N are saved as a respective training data set 200 generated for each data set 204. Validation data sets are generated similarly. This process may be repeated (decision block 210) until all desired training or validation data sets are generated and/or until all provided initial data sets 204 are processed.

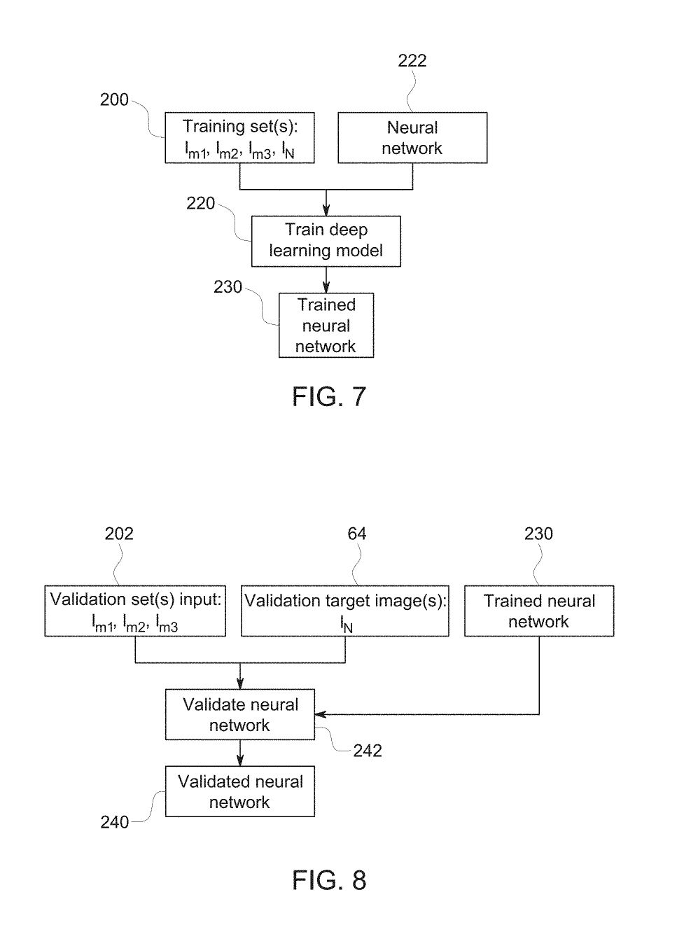

Turning to FIG. 7 the training (step 220) of a deep learning model is depicted. In this example, the deep learning model is trained using an artificial neural network 222 provided with the image estimates at low iteration numbers (i.e., Iₘ₁, 11112, and Iₘ₃,) as inputs and the estimates I_{N} at iteration N as the training target 64 to find an approximate functional mapping between the input and the target (FIG. 1) and thereby generate a trained deep learning model 230. The neural network structure could comprise an input layer 54, multiple hidden layers (e.g., 58A, 58B, and so forth), and an output layer 60, as shown in FIG. 1. In certain embodiments, a convolutional neural network with or without POOL layers, fully convolutional network, recurrent neural network, Boltzmann machine, deep belief net, or the long short-term memory (LSTM) network, is employed.

In some implementations, some or all of the inputs used to train the deep learning model could be difference images between an early iteration image (or patch) and another corresponding early iteration image or patch (e.g., {Iₘ₁, Iₘ₂-Iₘ₁, Iₘ₃, etc.} or {Iₘ₁, Iₘ₂, Iₘ₃-Iₘ₂, etc.}. Likewise, in some instances the inputs could include image feature descriptors, such as gradient and edges, obtained from the early estimates {Iₘ₁, Iₘ₂, Iₘ₃}. In some cases, hyper-parameters used by penalized iterative algorithms, such as the prior weight β, or a transformation of the hyper-parameters and data such as κ (Kappa) used in a PET image reconstruction which combines the hyper-parameter and data dependency, could also be part of the input to the network. Further, in certain embodiments some or all of the early iteration image estimates (or difference images, or feature descriptors) generated for training may be of reduced size to speed up the network training process. In such reduced size implementations, the network prediction, when applied in a non-training context (i.e., a clinical or diagnostic context) can be scaled up to correspond to a regular size reconstruction.

Turning back to FIG. 1, a loss function 62 that measures the difference between the network output I_{pred} 60 and the training target 64 I_{N} is computed for backpropagation. The loss function 62 could be the mean squared error (MSE) of the voxel-level value and may include differences involving other image features, such as image gradients or other image statistics. The loss function 60 may alternatively, be another metrics defined by the particular task.

In one implementation, the weights and biases of the trained neural network 230 are updated using backpropagation by optimization algorithms such as stochastic gradient decent, Adam, AdaGrad, RMSProp, or transferred and optimized from a pre-trained neural network 222. The hyper-parameters of the trained network 230, such as the number of layers (54, 58A, 58B, 60, etc.) and the number of neurons 56 for each layer, the number of convolutional kernels and the size of these kernels in the case of convolutional neural network, and the hyper-parameters for the optimization algorithms used to update the neural network training can be chosen through random grid search, optimization algorithms, or simple trial and error. Techniques like dropout may be used to avoid overfitting of the network 230. In some implementations, validation data sets were used to validate the trained neural network. Turning to FIG. 8, validation data sets 202 are employed (step 242) during the training to evaluate the generalization power of the trained neural network 230 and fine-tune some of the hyper-parameters. This validation process and the training procedure in FIG. 7 can be alternatingly conducted until yielding a validated neural network 240.

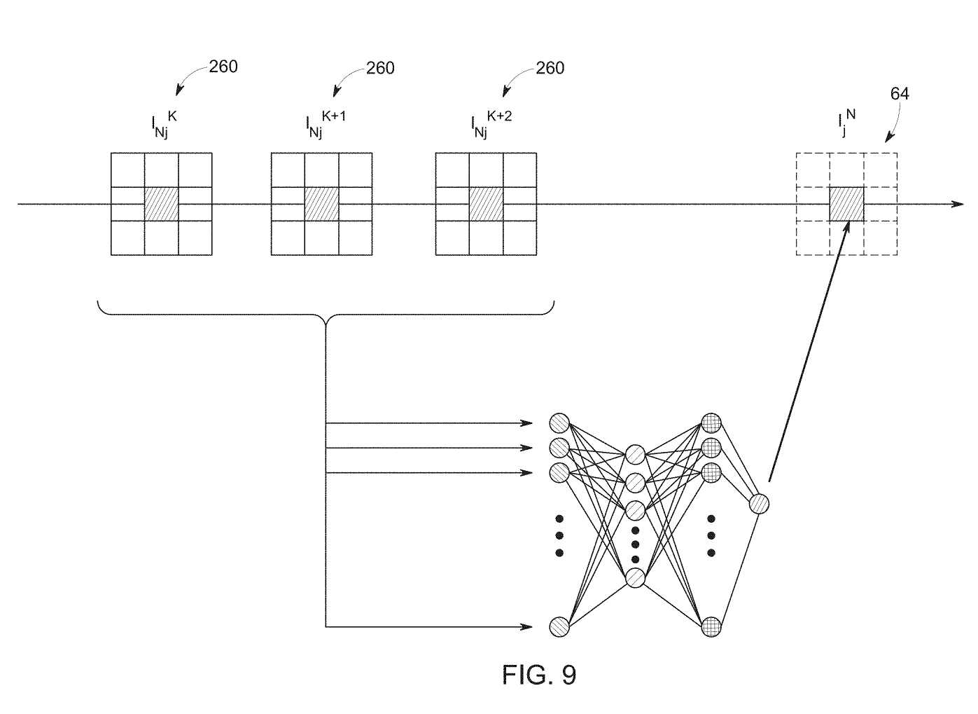

Turning back to training, a further example is explained with reference to FIG. 9. In some instances, the input to the neural network 222 undergoing training (step 220) could be image patches (e.g., limited subsets or array of pixels or voxels) of the early estimates 260 (here, I_{Nj}^{K}, I_{Nj}^{K+1}, I_{Nj}^{K+2}) and the training target 64 (here, Iⱼ^{N}) could be a corresponding image patch or a smaller region, e.g. even one voxel. In the depicted example, voxel j and its neighbors (in 2D or 3D or n dimensions; or generally a number of related unknowns represented as neighborhood Nj) are first estimated through regular iterative updates resulting in iterations K, K+1 and K+2, which are then used as the input to the deep learning network being trained (e.g., neural network 222). The output of the network will be compared with training target 64, i.e. the estimate at iteration N with regular updates for voxel j.

With the preceding in mind, it is possible to train a series of neural networks in this fashion, such as different models or networks for different stages of an iterative reconstruction process. For example, a first neural network may be trained by using early estimates (Iₘ₁, Iₘ₂, and Iₘ₃) as input and an estimate I_{N1} at iteration number N1 as the first target image where N1>m3. A second neural network may then be trained using I_{N1} as an input and an estimate I_{N2} at iteration N2 as the target image, where N2>N1. These sub-networks can be cascaded to form one deeper neural network and serve to pre-train and initialize a final, deeper network, so that the final network can achieve faster convergence and better performance.

In one implementation of such an embodiment, the hidden layers (i.e., layers 58A, 58B, and so forth) in the proposed deep networks can be pre-trained layer-by-layer by leveraging the intermediate iterates of a conventional iterative algorithm. For example, consider a L-layer network that takes I_{K} and I_{N} as the training input and training target, respectively. Pre-training of the S-th layer of the network could take I_{K+S-1} as the input, and I_{K}+s (where (K+S)<N) as the training target.

It may also be appreciated that while the preceding discussion suggests the use of iteratively reconstructed images as inputs to a trained deep learning model to accelerate an iterative reconstruction process, in practice it may be possible to use images reconstructed using other algorithms as inputs to the trained deep learning model. By way of example, in such implementations the input images to the trained neural network may be reconstructed using approaches that are faster than the iterative reconstruction under consideration, such as analytical reconstruction approaches (e.g., Feldkamp-Davis-Kress (FDK) or filtered back projection (FBP)) or other fast iterative reconstruction method such as ordered subset expectation maximization (OSEM). In essence, images obtained from other algorithms correspond to some points on the convergence curve of the iterative reconstruction method under consideration.

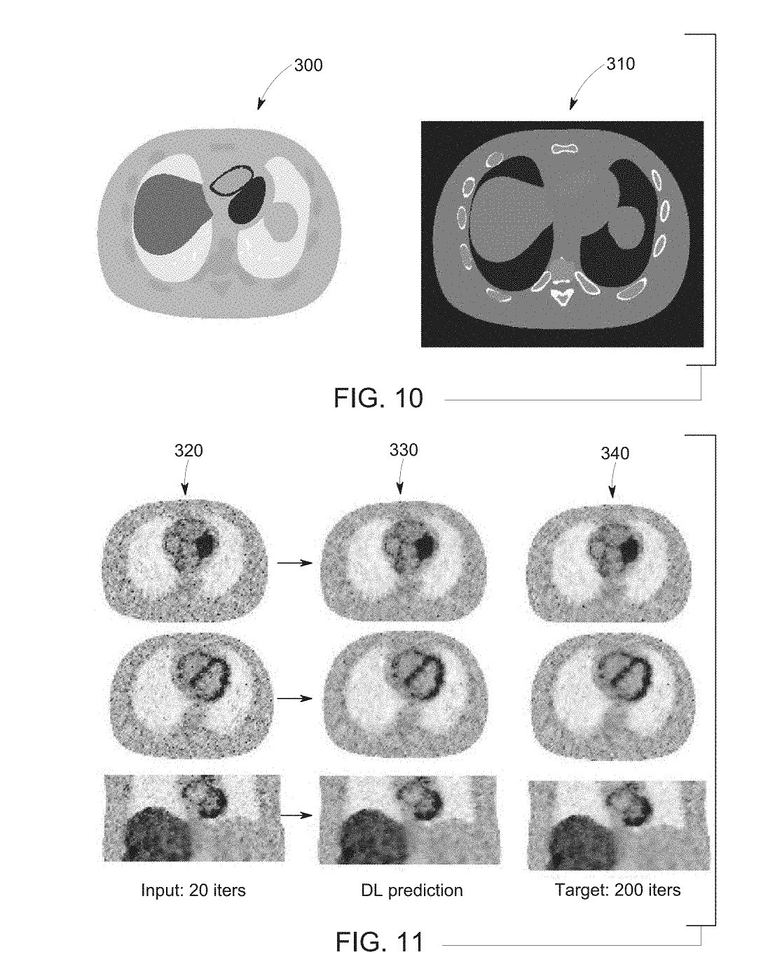

While the preceding outline the underpinnings and variations on the present approach, FIGS. 10-12 demonstrate results of a study performed using deep learning to accelerate iterative image reconstruction as discussed herein. In this study two-dimensional (2D) PET non-time-of-flight (non-TOF) data was generated using a NURBS-based cardiac torso (NCAT) phantom and the geometry of a GE Discovery PET/CT 710 geometry. An example of the emission phantom 300 and attenuation phantom 310 are shown in FIG. 10. In this study 600 noise realizations were generated, 500 of which were used as the training data set (i.e., to train the neural network corresponding to the deep learning acceleration model), 50 were used as a validation data set to avoid over training and fine-tune the parameters of the neural network, and the remaining 50 were used as test data. A penalized iterative reconstruction algorithm with relative difference penalty (RDP) as the prior, i.e., block sequential regularized expectation maximization (BSREM), was run up to 200 iterations. Other priors, such as quadratic penalty, total variation, generalized Gaussian, or their patch-based counterpart, can also be used. 2D axial slices were used as inputs to the network for training, validation, and testing. Slices from coronal or sagittal views can also be used for the study. The mean squared error (MSE) between the prediction image and the target image is used as the loss function for the neural network. Therefore, the network training was based on 2D input image-target image pairs with each input-target image pair based on different anatomy, activity distribution, and noise such that each pair of images was different.

With respect to network training, the network employed was defined as having three convolutional layers with a rectified linear unit (ReLU) activation function without POOL layers. Layer 1 was defined as a 3×3 kernel with 36 filters; Layer 2 was defined as a 3×3 kernel with 16 filters; and Layer 3 was defined as a 5×5 kernel with 1 filter. Images from the 20th iteration were used as input images for training while images from the 200^{th} were used as target images. As noted in the preceding sections, it would also have been possible to use images from multiple iterations as inputs (e.g., the 10th, 20th, and 30th iterations) and/or using neighboring slices as part of the input data. Thus, an input image corresponding to a 20^{th} iteration image is fed to a deep learning model (embodied as a neural network) so as to allow the model to learn how to estimate a 200^{th} iteration image from the input image. Thus, the resulted deep learning network was trained to receive as input images (here 2D slices) run to the 20^{th} iteration using BSREM and to output predicted images (here 2D slices) that have a cost function value corresponding to that of an image that would be generated by BSREM with an iteration number larger than the initial 20 iteration step. BSREM reconstruction was then further applied using the predicted images as an initialization.

Turning to FIG. 11, three examples are shown of the results of the study, with each row of images corresponding to a different slice or view of the 3D image volume. The first column of images corresponds to the input images 320, i.e., 20^{th} iteration images that were not used to train the deep learning model (i.e., test data). The second column corresponds to the deep learning predicted image 330 based on the corresponding input image 320. The third column corresponds to the actual target image 340 for the respective input image 320 generated using 200 iterations of BSREM. As may be visually observed, the predicted images 320 are closer in appearance to the target images 340 than to the input images 320. The MSEs between the predicted images 320 and the target images 340 were computed and found to be much smaller than the MSEs between the input images 320 and the target images 340.

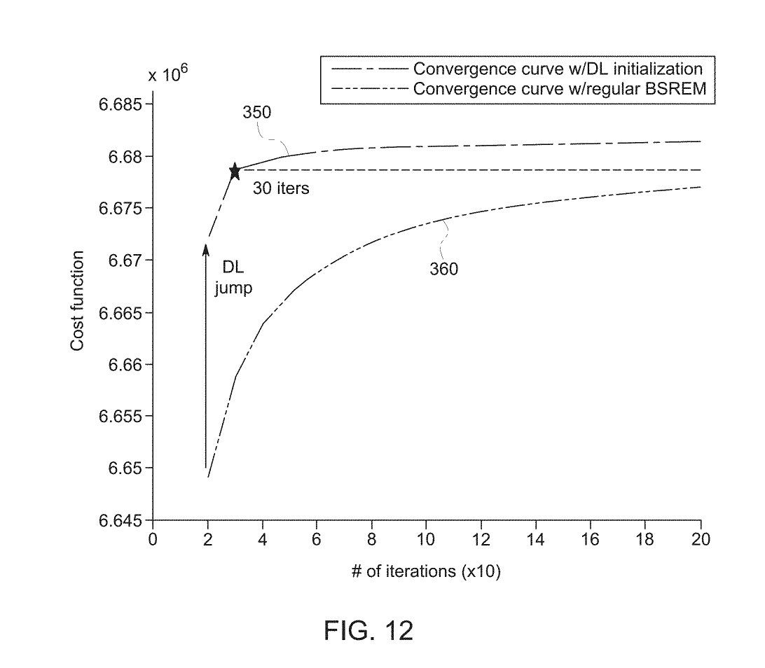

As previously noted, in the iterative reconstruction context, the purpose of iterative steps is to maximize or minimize the cost function. Therefore, acceleration provided by the present approach may be evaluated in terms of cost functions changes (i.e., was acceleration gained in terms of the cost function). In this particular study, the goal is to maximize a cost/objective function. This analysis is shown for the present study in FIG. 12, where the cost function curve over iterations is shown, with the cost function shown on the vertical axis of the graph and the number of iterations (×10) is shown on the horizontal axis. Two curves are plotted, the upper curve 350 depicting the convergence curve with deep learning acceleration as described above and the lower curve 360 depicting the regular convergence curve without such acceleration.

As shown in the plotted graph BSREM was run for 20 iterations and deep learning based acceleration was used to obtain predicted images which were then used to re-initialize the BSREM algorithm in the deep learning accelerated portion of the study. As may be observed, deep learning based acceleration produced a substantial jump in the cost function, reflecting a much faster convergence. Indeed, not only was a large jump in the objective function observed, but the deep learning based acceleration effectively moved reconstruction onto a faster convergence track. Indeed, in this study even after 200 iterations of BSREM on the un-accelerated track (toward the upper right end of the curve), a cost function level is still not reached that is comparable to what was seen on the accelerated track in only 30 iterations. This indicates an acceleration of at least a factor of seven using deep learning based acceleration for this study.

Technical effects of the invention include utilizing deep learning techniques to accelerate iterative reconstruction of images, such as CT, PET, SPECT, and MR images. In particular, projection (or other) data acquired by an imaging system may be iteratively reconstructed using deep learning approaches to accelerate the reconstruction processing. The present approach utilizes deep learning techniques so as to provide a better initialization to one or more steps of the numerical iterative reconstruction algorithm by learning a trajectory of convergence from estimates at different levels of convergence so that it can reach the maximum or minimum of a cost function faster. In essence the present approach may be construed as taking one or more images at one or more stages of the iterative reconstruction and using trained deep learning algorithms to obtain an estimate of what the image will look like for some number of iterative reconstruction steps in the future (e.g., 10, 50, 100, 200, 500, steps, and so forth). The estimated image may then be used in the iterative reconstruction so as to effectively move ahead that many steps in the reconstruction process, without performing the intervening iterative reconstruction steps.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A neural network training method, comprising:
acquiring a plurality of sets of scan data;
performing an iterative reconstruction of each set of scan data to generate one or more input images and one or more target images for each set of scan data, wherein the one or more input images correspond to lower iteration steps or earlier convergence status of the iterative reconstruction than the one or more target images; and
training a neural network to generate a trained neural network by providing the one or more input images and corresponding one or more target images for each set of scan data to the neural network.

2. The neural network training method of claim 1, further comprising generating a loss function that characterizes the difference between the one or more target images and predictions made by the neural network.

3. The neural network training method of claim 1, wherein the one or more input images comprise at least a subset of difference images generated by subtracting images generated at the lower iteration steps or earlier convergence status.

4. The neural network training method of claim 1, wherein the one or more input images comprise image feature descriptors or image patches and the target images comprise corresponding image feature descriptors or image patches.

5. The neural network training method of claim 1, wherein the one or more input images and corresponding target images are of a smaller size than the regular size of images which the trained neural network will be used to facilitate the reconstruction of.

6. An iterative reconstruction method, comprising:
acquiring a set of scan data;
performing an initial reconstruction of the set of scan data to generate one or more initial images;
providing the one or more initial images to a trained neural network as inputs;
receiving a predicted image or a predicted update as an output of the trained neural network;
initializing an iterative reconstruction algorithm using the predicted image or an image generated using the predicted update; and
running the iterative reconstruction algorithm for a plurality of steps to generate an output image.

7. The iterative reconstruction method of claim 6, wherein the initial reconstruction is an iterative reconstruction.

8. The iterative reconstruction method of claim 7, wherein the iterative reconstruction is one of an ordered subset expectation maximization (OSEM), penalized likelihood reconstruction, compressed-sensing reconstruction, algebraic reconstruction technique (ART), projection onto convex sets (POCS) reconstruction, or filtered versions of these iterative reconstructions.

9. The iterative reconstruction method of claim 6, wherein the initial reconstruction is an analytic reconstruction.

10. The iterative reconstruction method of claim 9, wherein the analytic reconstruction is one of a Feldkamp-Davis-Kress (FDK) reconstruction, a filtered back projection (FBP), or a filtered version of these reconstructions.

11. The iterative reconstruction method of claim 6, wherein the set of scan data is one of a set of computed tomography scan data, a set of positron emission tomography scan data, a set of single-photon emission computed tomography scan data, or a set of magnetic resonance imaging scan data.

12. The iterative reconstruction method of claim 6, wherein the predicted image has a cost function value corresponding to an iteratively reconstructed image obtained from performing a number of iteration steps on the one or more initial images.

13. The iterative reconstruction method of claim 6, further comprising:
providing the output image to the trained neural network or to a second trained neural network as a subsequent input;
receiving a second predicted image or a second predicted update from the trained neural network or the second trained neural network;
initializing a second instance of the iterative reconstruction algorithm using the second predicted image or a derived image generated using the second predicted update and running the second instance of the iterative reconstruction algorithm for a plurality of steps to generate a second output image.

14. The iterative reconstruction method of claim 6, wherein the iterative reconstruction algorithm reaches a cost function value in fewer iterations than if the iterative reconstruction algorithm were run on the set of scan data without generating the predicted image or predicted update using the trained neural network.

15. The iterative reconstruction method of claim 6, further comprising providing image feature descriptors or image patches in addition to the one or more initial images to the trained neural network.

16. The iterative reconstruction method of claim 6, further comprising providing hyper-parameters or a transformation of the hyper-parameters and scan data in addition to the one or more initial images to the trained neural network.

17. An imaging system comprising:
a data acquisition system configured to acquire a set of scan data from one or more scan components;
a processing component configured to execute one or more stored processor-executable routines; and
a memory storing the one or more executable-routines, wherein the one or more executable routines, when executed by the processing component, cause acts to be performed comprising:
performing an initial reconstruction of the set of scan data to generate one or more initial images;
providing the one or more initial images to a trained neural network as inputs;
receiving a predicted image or a predicted update as an output of the trained neural network;
initializing an iterative reconstruction algorithm using the predicted image or an image generated using the predicted update; and
running the iterative reconstruction algorithm for a plurality of steps to generate an output image.

18. The imaging system of claim 17, wherein the initial reconstruction is an iterative reconstruction.

19. The imaging system of claim 17, wherein the initial reconstruction is an analytic reconstruction.

20. The imaging system of claim 17, wherein the imaging system is one of a computed tomography imaging system, a positron emission tomography imaging system, a single-photon emission computed tomography system, or a magnetic resonance imaging system.

21. The imaging system of claim 17, wherein the predicted image has a cost function value corresponding to an iteratively reconstructed image obtained from performing a number of iteration steps on the one or more initial images.
